(19) United States
(12) Patent Application Publication
(10) Pub. No.: US 2024/0188549 A1
(43) Pub. Date: Jun. 13, 2024

(54) FISHING LURE

(71) Applicant: Steven Nemirsky, Edmonton (CA)

(72) Inventor: Steven Nemirsky, Edmonton (CA)

(21) Appl. No.: 18/065,332

(22) Filed: Dec. 13, 2022

(51) Int. Cl. A01K 85/00

(52) U.S. Cl. CPC A01K 85/029; A01K 85/1841

(57) ABSTRACT

A fishing lure that is configured to have the exterior thereof altered wherein the exterior can be provided in a different color or have alternate surface element features. The invention includes a body wherein the body includes at least one hook member and an attachment member. The fishing lure includes a housing wherein the housing is configured to be surroundably mounted to the body. The housing includes a first portion and a second portion that are releasably coupled so as to surroundably mount the housing to provide an alternate exterior appearance of the fishing lure. The housing is mateably shaped to the body with the first portion and second portion having a cavity so as to be able to receive approximately half of the body therein. The housing is provided in a different color and can include alternate surface elements so as to alter the appearance of the fishing lure.

### FIELD OF THE INVENTION

The present invention relates generally to fishing equipment, more specifically but not by way of limitation, an artificial fishing lure that can be employed in fresh water applications and saltwater application wherein the lure of the present invention is configured to have a removable housing in order to facilitate changing of features and/or colors.

### BACKGROUND

Fishing is very popular recreational sport that millions of individuals participate in on a regular basis. While there are many techniques and apparatus for catching fish, the most widely utilized equipment is a rod and reel. As is known in the art, rod and reels are employed to cast a bait to a desired location wherein the bait is either left in place or retrieved. Most natural baits are left in place while artificial baits are often retrieved. Artificial baits are widely used by fisherman and are available in numerous different styles, sizes and colors. Artificial baits are constructed differently to produce alternate types of action and effects when being retrieved.

One issue with artificial lures is the inability to change the color and/or features of the lure. Existing lures are provided in numerous sizes and colors for the same type of lure but if a fisherman desires to change the color then they must tie on a completely different lure. It is quite common for fisherman to employ a darker color lure in some water conditions while a lighter colored lure in alternate water conditions. This results in the fisherman having to buy two of the same lures except in different colors. Lures can be quite expensive and as such this can be undesirable for a fisherman. Additionally, it is sometimes time consuming to tie on a new lure while fishing and this can be disadvantageous for a fisherman as well.

Accordingly, there is a need for a fishing lure that is configured to allow a fisherman to change the color and/or features of the lure without having to replace the entire lure.

### SUMMARY OF THE INVENTION

It is the object of the present invention to provide a fishing lure that is configured to facilitate an ability for the color and features to be altered wherein the fishing lure of the present invention includes a body.

Another object of the present invention is to provide a configurable fishing lure that allows alteration of the elements such as but not limited to color and surface features wherein the present invention includes a housing that is configured to be releasably secured to the body.

A further object of the present invention is to provide a fishing lure that is configured to facilitate an ability for the color and features to be altered wherein the housing includes a first portion and a second portion.

Still another object of the present invention is to provide a configurable fishing lure that allows alteration of the elements such as but not limited to color and surface features wherein the first portion and second portion of the housing are configured to be releasably secured around the body.

An additional object of the present invention is to provide a fishing lure that is configured to facilitate an ability for the color and features to be altered wherein the housing is provided in a different color than the body.

Yet a further object of the present invention is to provide a configurable fishing lure that allows alteration of the elements such as but not limited to color and surface features wherein the first portion and second portion of the housing can include additional surface elements not present on the body.

Another object of the present invention is to provide a fishing lure that is configured to facilitate an ability for the color and features to be altered wherein the lure of the present invention is provided in alternate sizes and shapes.

An alternative object of the present invention is to provide a configurable fishing lure that allows alteration of the elements such as but not limited to color and surface features wherein the lure of the present invention is provided with alternate hook configurations.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the body of the present invention; and

FIG. 2 is a perspective view of the present invention with the housing removed from the body; and

FIG. 3 is a perspective view of the present invention with the housing secured to the body.

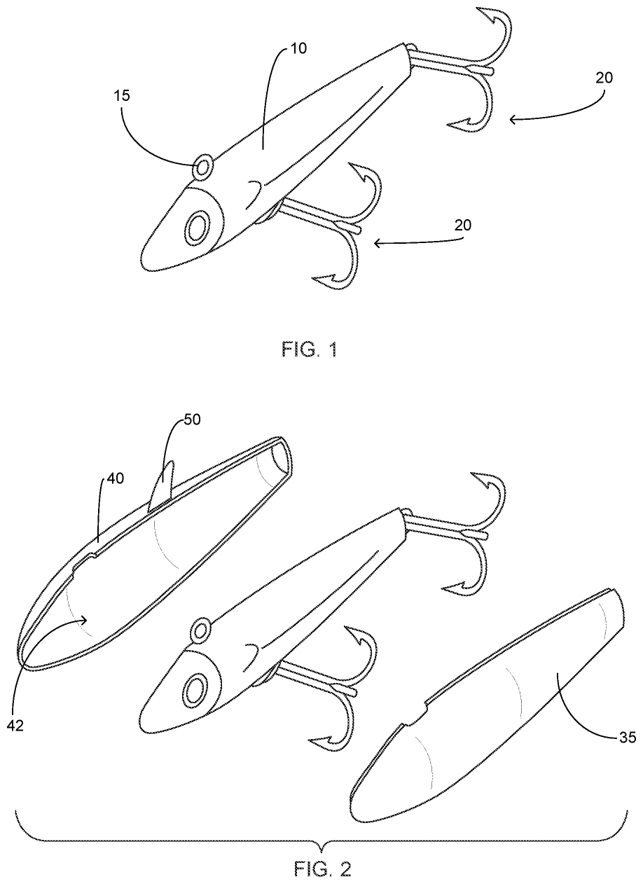

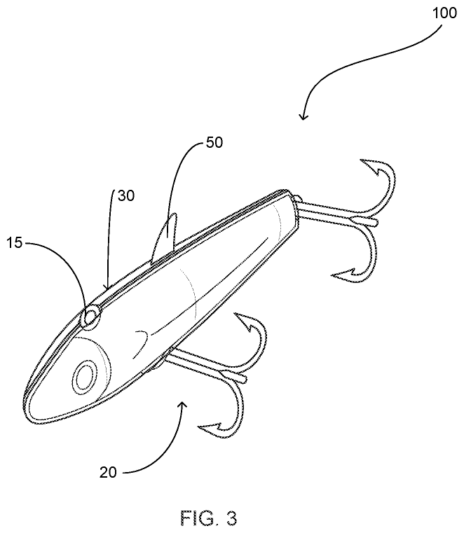

### DETAILED DESCRIPTION

Referring now to the drawings submitted herewith, wherein various elements depicted therein are not necessarily drawn to scale and wherein through the views and figures like elements are referenced with identical reference numerals, there is illustrated a fishing lure 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the fishing lure 100 includes a body 10. The body 10 is manufactured from a durable material such as but not limited to plastic. The body 10 while illustrated herein in a particular shape is provided in alternate shapes and sizes in order to be employed for different fishing environments and/or conditions. It is further contemplated within the scope of the present invention that the body 10 of the fishing lure 100 can be provided to either sink, suspend or float in the water. The body 10 includes attachment member 15 wherein attachment member 15 is a metal loop that is configured to have a fishing leader or line secured thereto. The body 10 further includes hook members 20 that are operably coupled to the bottom of the body 10. While two hook members 20 are illustrated herein, it is contemplated within the scope of the present invention that the body 10 could have more or less than two hook members 20. Furthermore, it is contemplated within the scope of the present invention that the hook members 20 could be provided in a treble hook as illustrated herein or in alternate hook configurations.

The fishing lure 100 includes a housing 30 wherein the housing 30 is configured to be releasably secured around the body 10. The housing 30 is comprised of a first portion 35 and a second portion 40 that are configured to mateably couple utilizing suitable durable techniques. The second portion 40 includes cavity 42 that is operable to accommodate approximately half of the body 10 when the housing 30 is surroundably mounted to the body 10. The first portion 35 is similarly constructed having a cavity (not particularly illustrated herein). The first portion 35 and second portion 40 releasably secure over the body 10 so as to provide complete coverage thereof. The housing 30 is configured with different surface characteristics than that of the body 10. By way of example but not limitation, the housing 30 is a different color than the body 10 and can further include alternate reflective material.

The housing 30 is further configured with alternate surface element members 50. The surface element member 50 is formed in either the first portion 35, second portion 40 or both utilizing suitable techniques. While the exemplary surface element member 50 illustrated herein is shaped to resemble a fin, it is contemplated within the scope of the present invention that the surface element member 50 could be provided in alternate shapes and sizes. Furthermore, it is contemplated within the scope of the present invention that the surface element member 50 could be located in various locations on the housing 30 as well as be provided in alternate quantities.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A fishing lure comprising:
a body, said body having an attachment member, said body having at least one hook member;
a housing, said housing having a first portion and a second portion, said first portion and said second portion being mateably shaped to said body, said first portion and said second portion being configured to be releasably secured to each other, said first portion and said second portion configured to be surroundably mounted to said housing.

2. The fishing lure as recited in claim 1, wherein said body has an exterior surface, said exterior surface having a first color thereon.

3. The fishing lure as recited in claim 2, wherein said housing has an exterior surface, said exterior surface of said housing having a second color thereon, wherein said second color is different than said first color.

4. The fishing lure as recited in claim 3, wherein said housing further includes at least one surface element member, said at least one surface element member extending outward from said exterior surface of said housing.

5. The fishing lure as recited in claim 4, wherein said body is configured to demonstrate characteristics in water selected from a group comprising of: suspend, sink or float.

6. A fishing lure configured to have an exterior appearance thereof altered wherein the fishing lure comprises:
a body, said body having an attachment member, said body having at least one hook member;
a housing, said housing having a first portion and a second portion, said first portion having a cavity configured to receive therein approximately half of said body, said second portion having a cavity configured to receive therein approximately half of said body, said first portion and said second portion being mateably shaped to said body, said first portion and said second portion of said body being equal in size and shape and configured to be releasably secured to each other, said first portion and said second portion configured to be surroundably mounted to said housing.

7. The fishing lure configured to have an exterior appearance thereof altered as recited in claim 6, wherein said housing further includes at least one surface element member, said at least one surface element member extending outward from said exterior surface of said housing.

8. The fishing lure configured to have an exterior appearance thereof altered as recited in claim 7, wherein said body has an exterior surface, said exterior surface having a first color thereon.

9. The fishing lure configured to have an exterior appearance thereof altered as recited in claim 8, wherein said housing has an exterior surface, said exterior surface of said housing having a second color thereon, wherein said second color is different than said first color.

10. The fishing lure configured to have an exterior appearance thereof altered as recited in claim 9, wherein said body is configured to demonstrate characteristics in water selected from a group comprising of: suspend, sink or float.
